(19) United States
(12) Patent Application Publication
(10) Pub. No.: US 2003/0234590 A1
(43) Pub. Date: Dec. 25, 2003

(54) Magnetic motor apparatus and method

(76) Inventors: Christopher Mark Gitzen, Fountain, CO (US); Daniel S. Pendl, Aiea, HI (US); Justin O. Storto, Ewa Beach, HI (US)

Correspondence Address: Francis A. Sirr, HOLLAND & HART LLP, P.O. Box 8749, Denver, CO, 80201, US

(21) Appl. No.: 10/174,610

(22) Filed: Jun. 19, 2002

(51) Int. Cl. H02K 21/00

(52) U.S. Cl. 310/152

(57) ABSTRACT

The rotor and stator of a motor are separated by an air gap The rotor presents a plurality of magnetic flux windows of a given magnetic polarity to the air gap, and the stator provides a different number of magnetic flux windows of the given magnetic polarity to the air gap. The rotor carries a number of equally-spaced bar-type magnets, each magnet of which presents a magnetic pole of the given polarity, for example, a north pole to the air gap The stator carries a different number of equally-spaced bar-type magnets, each magnet of which presents a north pole on the other side of the air gap The rotor and stator carry a number of magnetic flux shields that are made of a material having a high magnetic permeability, for example, mumetal These flux shields are placed on the rotor and on the stator such that the rotor presents a number of equally-spaced north magnetic flux windows to the air gap, and such that the stator presents a different number of equally-spaced north magnetic flux windows to the air gap. In any position of the rotor, at least one rotor flux window interfaces with at least one stator flux window to thereby cause the rotor to be magnetically repelled from the stator As a result of movement of the rotor, a currently-open flux window pair closes, as another flux window pair opens, to thereby effect a continuous movement of the rotor. To stop the rotor, one or both of the rotor and stator flux shields, and preferably the stator flux shields, are moved so that at least one, and preferably all, of the flux window pairs close.

### BACKGROUND OF THE INVENTION

1. Field of the Invention

This invention relates to the field of motor or prime mover structures wherein movement of a movable member results from the repulsion of magnetic fields that are carried by the movable member and magnetic fields that are carried by a stationary member, and more specifically, to a machine or mechanism that transforms magnetic energy into mechanical energy.

2. Description of the Related Art

The present invention provides a family of new, unusual and unobvious magnetic motors.

Magnetic motors are known in the art For example. U.S. Pat. No. 6,323,572 to Kinosihita provides a magnetic-type electric motor and generator. FIGS. 2A-2F of this patent show six embodiments of an outer rotor magnet-type generator having a number of division iron cores and a number of radially-extending magnets, whereas FIGS. 3A-3F of this patent show six embodiments of an inner rotor magnet-type generator that has a reverse structure to that shown in FIGS. 2A-2F.

### SUMMARY OF THE INVENTION

While both electromagnets and permanent magnets can be used separately or concurrently within the spirit and scope of this invention, preferred embodiments of the present invention make use of powerful permanent magnets, and preferably permanent magnets that include neodymium (Nd).

Electromagnets, permanent magnets, or a combination thereof, can be used in accordance with the present invention to generate magnetic fields that extend external to the magnets. Such an external magnetic field (H) is a vector quantity that is measured in amperes per meter (A/m) in the KMS system, or in Oersteds (Oe) in the CGS system.

Permanent magnets of the preferred neodymium-type are known; for example, Nd/Fe/B (neodymium/iron/boron) magnets are known. It is also known that neodymium magnets have been used in the voice coil actuators of hard disk drives.

The present invention makes use of magnetic flux shields or magnetic flux barriers having a high magnetic permeability.

It is known that high nickel, magnetically soft alloys have been used to provide magnetic shielding for a variety of electronic devices An alloy of this type is mumetal; for example, a Ni80/Fe20 alloy or a Ni77/Fe14/Cu5/Mo4 alloy. Mumetal is known to provide ultra high magnetic permeability, for example as high as 1,000,000+ gauss/oersted, whereas the permeability of air is known to be about 1 gauss/oersted

The present invention makes use of the fact that when a magnetic field (H) emanates from a magnet and then permeates through the cross-sectional area of a medium such as a magnetic flux shield or flux barrier of the present invention, the magnetic field or magnetic flux converts to magnetic flux density (B) as a function of the permeability of the magnetic flux shield or flux barrier wherein the value B increases as a direct function of the permeability of the material that is used to make the magnetic flux shield or flux barrier.

In motors constructed and arranged in accordance with the present invention, a rotor and a stator are separated by an air gap. The rotor presents a plurality of magnetic flux windows of a given magnetic polarity to the air gap, and the stator provides a different number of magnetic flux windows of the given magnetic polarity to the air gap. The term “given magnetic polarity” as used herein can mean either a north magnetic pole or a south magnetic pole.

The rotor carries a number of equally spaced bar-type magnets, each magnet of which presents a magnetic pole of the given polarity to the air gap, for example, a plurality of equally spaced north magnetic poles are presented to one side of the air gap.

The stator carries a different number of equally spaced bar-type magnets, each magnet of which presents a north magnetic pole the other side of the air gap.

Each of the rotor and stator carries a number of magnetic flux shields that are made of a material having a high magnetic permeability, a non-limiting example being mumetal. These flux shields are placed on the rotor and on the stator such that the rotor presents a number of equally spaced north magnetic flux windows to the air gap, and such that the stator presents a different number of equally spaced north magnetic flux windows to the air gap.

In any position of the rotor, at least one rotor flux window interfaces with at least one stator flux window to a greater extent than any other combination of flux windows interact. This causes the rotor to be magnetically repelled from the stator. As a result of rotor movement, a currently-open window pair closes as another window pair opens, to thereby effect continuous movement of the rotor. In order to stop the rotor, one or both of the rotor and stator flux shields (and preferably the stator flux shields) are moved so that at least one (and preferably all) of the flux window pairs is closed.

As a feature of the invention, a continuous or 360-degree flux shield can be inserted into the 360-degree air gap to stop rotation of the rotor

### BRIEF DESCRIPTION OF THE DRAWING

FIG. 1 is a top view of a rotary motor constructed and arranged in accordance with the invention, wherein this embodiment of the invention includes a stator or stationary member that encircles a rotor or movable member, wherein the stator carries five permanent magnets that are 72-degrees spaced, and wherein the rotor carries four permanent magnets that are 90-degrees spaced.

FIG. 2 is a perspective view of the motor of FIG. 1 wherein it is shown that the FIG. 1 stator includes slots that enable adjustment of the mounting angle of the five permanent magnets that are carried by the stator.

FIG. 3 is an enlarged view of a currently-operative rotor magnet and stator magnet, and a force diagram showing the force vector that produces movement of the FIG. 1 rotor.

FIG. 4 is an exploded perspective view of a stator magnetic shielding collar and a rotor magnetic shielding collar that are used to control the magnetic flux that emanates from the five stator magnets and the four rotor magnets shown in FIG. 1.

FIG. 5 is a simplified view, similar to FIG. 2 that shows a cylindrical or 360-degree flux shield can be inserted into the circular air gap of the FIG. 1 motor in order to stop rotation of the rotor

### DESCRIPTION OF THE PREFERRED EMBODIMENTS

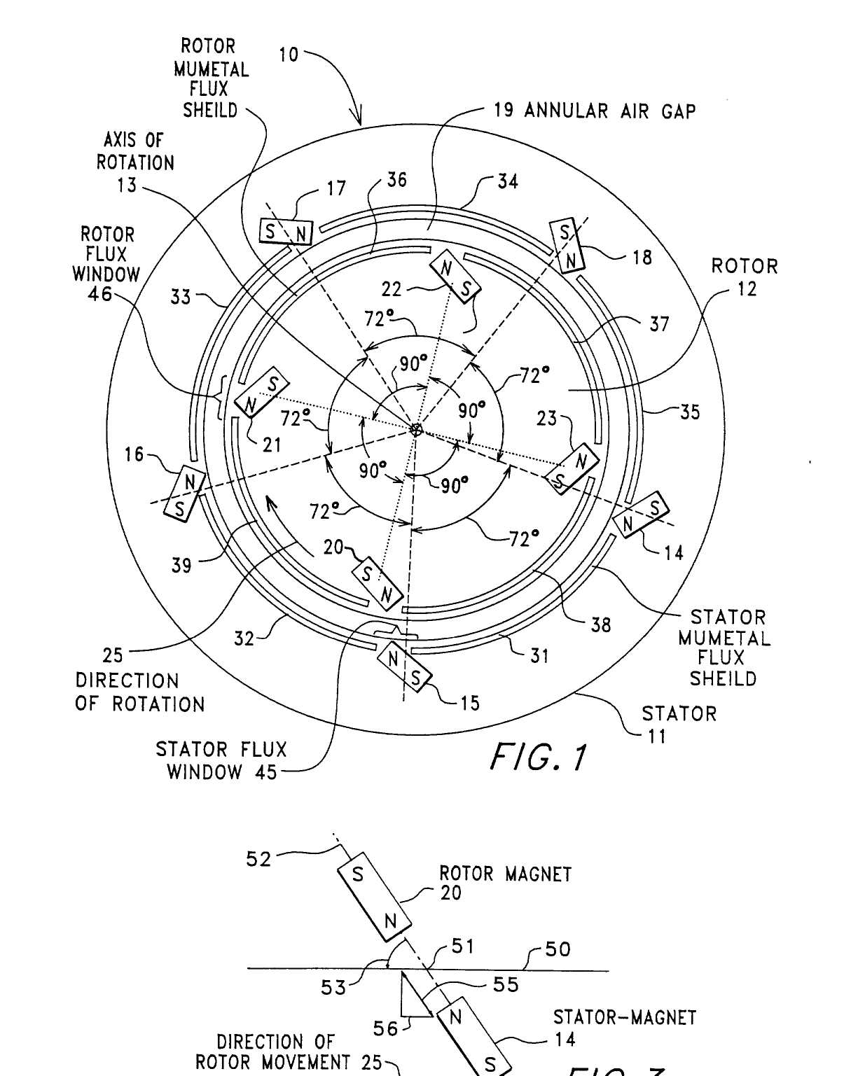

FIG. 1 is a top view of a rotary motor 10 that is constructed and arranged in accordance with the invention.

While the spirit and scope of the invention provides that the motor rotor may either encircle the stator or that the motor stator may encircle the rotor, in the FIGS. 1, 2 and 4 embodiment of the invention, a circular and non-magnetic stator or stationary member 11 encircles a circular and nonmagnetic rotor or movable member 12 that rotates on an axis of rotation 13 By way of a non-limiting example, stator 11 and rotor 12 may be formed of aluminum.

Rotor 12 and stator 11 are separated by a circular or annular air gap 19 that is at all points equidistant from axis 13. Air gap 19 provides a uniform separation between the two facing surfaces of rotor 12 and stator 11 throughout the entire 360-degrees of air gap 19.

As best seen in FIG. 1, stator 11 carries five magnets 14-18 that are equally spaced circumferentially about axis 13 and that are equally spaced radially from axis 13. Since this embodiment of the invention uses five stator magnets 14-18, the magnets are circumferentially spaced at 72-degrees about axis 13.

Also as best seen in FIG. 1, rotor 12 carries four magnets 20-23 that are equally spaced circumferentially about axis 13, and that are equally-spaced radially from axis 13. Since this embodiment of the invention uses four rotor magnets 20-23, the magnets are circumferentially spaced at 90-degrees about axis 13.

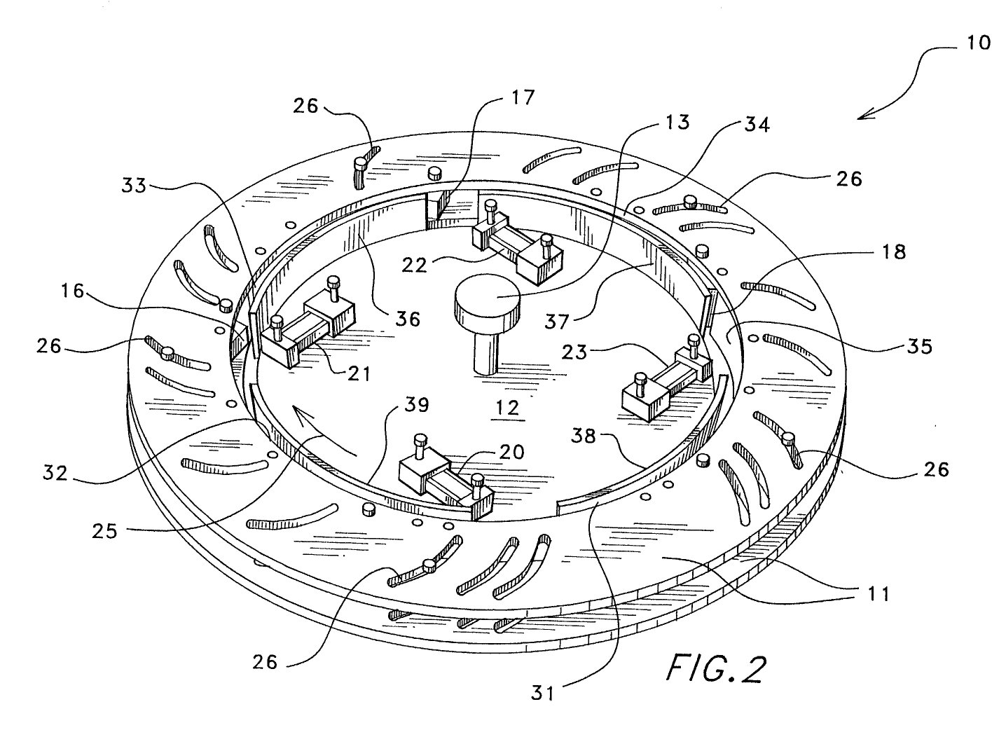

In more general terms and within the spirit and scope of this invention, an integer number X of equally-spaced magnets are provided on rotor 12, each of these rotor magnets presenting a magnetic pole of a given polarity to air gap 19. In the FIG. 1 and 2 embodiment of the invention, the integer number X is 4, the equal circumferential spacing is 90-degrees, and each rotor magnet presents a north magnetic pole to air gap 19.

Also in more general terms, a different integer number Y of equally-spaced magnets are provided on stator 11, each of these stator magnets presenting a magnetic pole of the given polarity to air gap 19. In the FIGS. 1 and 2 embodiment of the invention, the integer number Y is 5, the equal circumferential spacing is 72-degrees, and each stator magnet presents a north magnetic pole to air gap 19.

While the embodiment of the invention described herein utilizes five permanent rotor magnets 14-18 and four permanent stator magnets 20-23 it is within the spirit and scope of the invention to use electromagnets, permanent magnets, or a combination of electromagnets and permanent magnets, with permanent magnets being preferred for use at least on rotor 12 due to the added complexity of providing electrical current to a moving member.

When permanent magnets are selected for use in accordance with the invention, it is preferable that strong permanent magnets be used, for example, permanent magnets that contain neodymium of which neodymium/iron/boron permanent magnets are a non-limiting example

Again more generally, and within the spirit and scope of the invention, the number of equally-spaced magnets on rotor 12 can be said to equal X magnets, and the different number of equally-spaced magnets on stator 11 can be said to equal Y magnets, wherein the numbers X and Y are integers, wherein X is not divisible by Y, wherein Y is not divisible by X, and wherein the two numbers X and Y are not both divisible by any other common integer number By way of a non-limiting example, a ratio of the number of magnets on rotor 12 to the different number of magnets on stator 11 can be selected from a ratio group consisting of a 4-to-5 ratio, a 4-to-7 ratio and a 4-to-9 ratio.

In the relative positions of rotor 12 and stator 11 shown in FIG. 1. rotor magnet 20 is in general alignment with stator magnet 15 Stated another way, magnet 20 and magnet 15 comprise an operative magnet pair. As a result of the north magnetic pole repulsions of these magnets 20 and 15, a force is imparted to rotor 12, causing rotor 12 to move as is depicted by arrow 25. In view of the 90-degree spacing of the four rotor magnets and the 72-degree spacing of the five stator magnets, movement 25 operates to reduce the repulsion force that is generated by a current magnet pair 15, 20 while at the same the time another magnet pair 14, 23 that is located in a direction that is opposite to direction 25 is brought into a state of magnetic field repulsion. thus continuing movement of rotor 12 in direction 25

This continuous rotational force is applied to rotor 12 as one magnet pair moves out of a repulsion state as a different magnet pair moves into a repulsion state.

The repulsion force that is applied to rotor 12 is enhanced by, tilting stator magnets 14-18 in the direction of rotor movement 25, and by tilting rotor magnets 20-23 in an opposite direction to the direction of rotor movement 25.

In accordance with a feature of the invention, FIG. 2 shows that stator 11 includes five slots 26 that enable individual adjustment of the mounting angle of the five magnets 14-18 that are carried by stator 11.

The present invention provides a number of magnetic flux shields on both stator 11 and rotor 12 to enhance the switching of the rotor magnetic repulsion force between individual stator magnet and rotor magnet pairs These magnetic flux shields operate to maximize the rotational force and torque that is applied to rotor 12.

Thus, as best shown in FIG. 1, stator 11 carries five equally-spaced (72-degree spacing) magnetic flux shields 31-35 having a high magnetic permeability, and rotor 12 carries four equally spaced (90-degree spacing) magnetic flux shields 36-39 having a high magnetic permeability A non-limiting example of a material for use in fabricating flux shields 31-39 is mumetal; i.e., a high nickel and magnetically soft alloy, examples of which include Ni80/Fe20 and Ni77/Fe14/Cu5/Mo4.

The arrangement of magnetic flux shields 31-39 about axis 13 is such that each rotor magnet and each stator magnet is provided with a north pole flux window at the location of air gap 19. For example, reference numeral 45 in FIG. 1 identifies the stator flux window for stator magnet 14, and reference numeral 46 in FIG. 1 identifies the rotor flux window for rotor magnet 21. In a like manner, each rotor magnet and stator magnet is provided with its own individual north pole magnetic flux window.

As a result, stator 11 and rotor 12 each present a plurality of magnetic flux windows of a given magnetic polarity to air gap 19, with stator 11 providing a different number of magnetic flux windows than does rotor 12

In the FIG. 1 and 2 embodiment of the invention, rotor 12 carries a number of equally spaced bar-type magnets, each magnet of which presents a north magnetic pole to one side of air gap 19, whereas stator 11 carries a different number of equally-spaced bar-type magnets, each magnet of which presents a north magnetic pole the other side of air gap 19

Each of rotor 12 and stator 11 carries a number of magnetic flux shields that are made of a material having a high magnetic permeability, an example material being mumetal. These flux shields are placed on rotor 12 and stator 11 such that rotor 12 presents a number of equally spaced north magnetic pole flux windows to air gap 19, and such that stator 11 presents a different number of equally spaced north magnetic pole flux windows to air gap 19.

In any position of rotor 12, at least one rotor flux window operatively interfaces with at least one stator flux window to thereby cause rotor 12 to be magnetically repelled from stator 11. As a result of movement 25 of rotor 12, a currently-open flux window pair closes, as another flux window pair opens, to thereby effect a relatively continuous movement of rotor 12

FIG. 3 is an enlarged view of the currently operative rotor magnet/stator magnet pair 20/14 that is shown in FIG. 1. Line 50 of FIG. 3 is a tangent to the centerline (not shown) of air gap 19 at a point 51 whereat a centerline 52 of rotor magnet 20 and stator magnet 14 intersects the centerline of air gap 19.

While rotor magnet 20 and stator magnet 14 are shown as having a common centerline 52 and thus a common angle of tilt 53, this need not be the case in accordance with the present invention. That is, the tilt angle of stator magnet 14 can be changed by the use of slots 26 shown in FIG. 2 wherein clamping means (not shown) is provided to hold each stator magnet 14-18 in an adjusted position.

By way of example only, angle of tilt 53 can be in a range of from about 0-degrees to about 45-degrees.

In FIG. 3, a force vector 55 represents the magnetic force of repulsion that is generated relative to stator 11 as the north magnetic poles of rotor magnet 20 and stator magnet 14 mutually repel each other. A component 56 of force vector 55 represents a resultant force that produces movement 25 of rotor 12.

As the number of rotor magnets and stator magnets is increased, the rotational movement of rotor 12 becomes more uniform and, in fact, conventional means such as a flywheel can be used to provide a relatively constant speed of rotation of rotor 12, if desired.

In order to stop the movement of rotor 12, one or both of the rotor and stator flux shields (and preferably the stator flux shields 31-35) are moved so that at least one (and preferably all) of the flux window pairs are closed

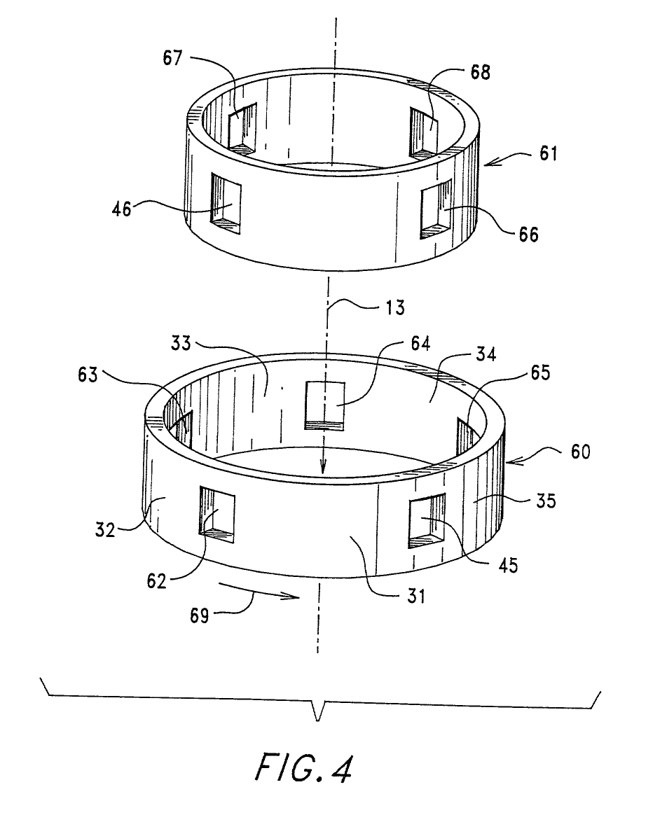

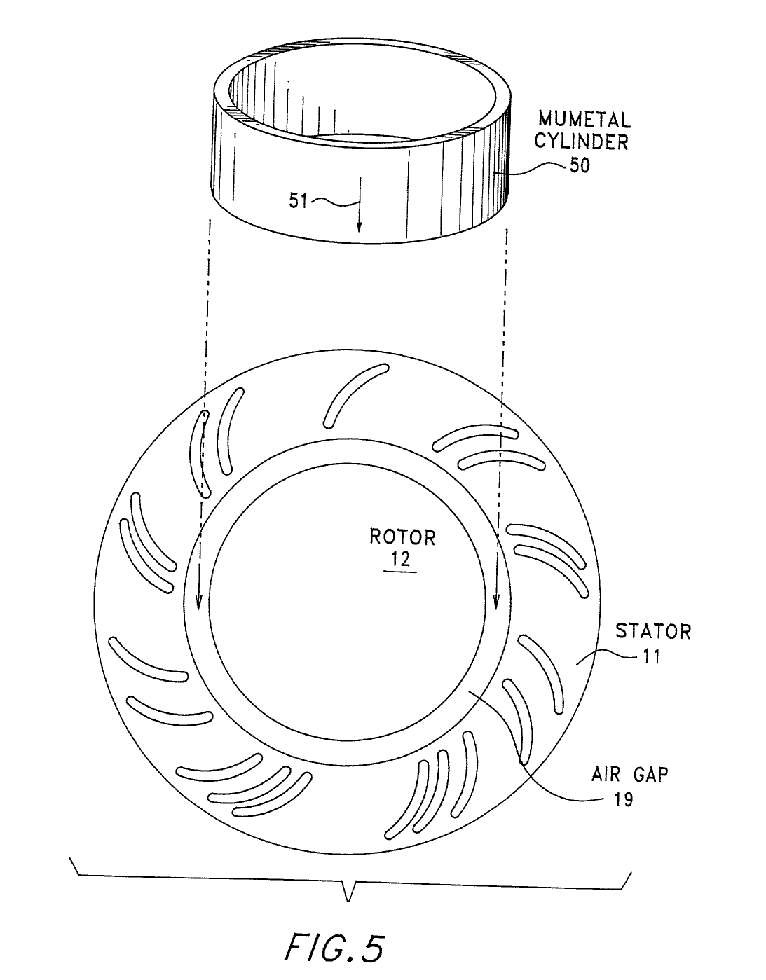

FIG. 4 is an exploded perspective view of a stator magnetic flux shielding collar 60 and a rotor magnetic flux shielding collar 61 that are used to control the magnetic flux that emanates from the five stator magnets 14-18 and the four rotor magnets 20-23 shown in FIG. 1.

Each of these collars 60, 61 is formed of a material having a high magnetic permeability, each of these collars is formed as a circular cylinder about axis 13, and each of these collars includes an open flux window whose shape corresponds generally to the shape of the north pole end of its respective magnet.

Thus, stator magnetic shielding collar 60 includes five, 72-degree spaced, open flux windows 45, 62, 63, 64, and 65, whereas rotor magnetic shielding collar 61 includes four, 90-degree spaced, open flux windows 66, 46, 67, and 68.

As shown in FIG. 4, stator flux window 45 is in radial alignment with rotor flux window 66. Thus, flux window pair 45, 66 is the only open flux window pair. This relative position of stator magnetic shielding collar 60 and rotor magnetic shielding collar 61 allows the north pole of rotor magnet 20 to interact with the north pole of stator magnet 14 as above described.

In order to stop rotation of rotor 12, at least one of the two magnetic shielding collars 60, 61 is rotated about axis 13 to a position where no open flux window pair exists. Without limitation thereto, stator magnetic shielding collar 60 is moved in the direction shown by arrow 69 in FIG. 4.

FIG. 5 shows another means by which the rotation of rotor 12 may be stopped. More specifically, FIG. 5 is a simplified view, similar to FIG. 2, that shows a cylindrical or 360-degree flux shield 50 that can be inserted downward into circular air gap 19 in order to stop rotation of rotor 12.

By way of a non-limiting example, cylindrical mumetal shield 50 may be latched in the upward and inoperative position shown in FIG. 5 against the force of a spring (not shown) When it is desired to stop rotor 12 a release mechanism (not shown) can be activated to cause mumetal shield 50 to move downward as a result of the force of the spring as indicated by arrow 51, and into air gap 10. This position of mumetal shield 50 operates to totally interrupt the above-described magnetic repulsion forces that cause rotor 12 to move.

As an example of the utility of the FIG. 5 feature, an over-speed sensor (not shown) can be provided to release mumetal shield 50 should the speed of rotation of rotor 12 become excessive, or mumetal shield 50 may be manually released to protect individuals working on the motor and/or mechanisms being driven by rotor 12.

While specific examples of magnetic flux shielding have been described, within the spirit and scope of this invention additional shielding means can be provided to isolate the various rotor magnets and stator magnets from each other, as may be needed or desired in any given rotor/stator configuration.

While the above description has provided that stator 11 encircle rotor 12, the spirit and scope of the invention includes embodiments of the invention wherein the rotor encircles the stator.

While the above-detailed description relates to specific embodiments of the invention, it is not intended that this detailed description be taken as a limitation on the spirit and scope of the invention.

What is claimed is:

1. A motor comprising:
a rotor mounted for rotation about an axis and in a direction of rotation;
a stator non-movably mounted to encircle said axis and to define an annular air gap between said stator from said rotor;
a plurality N of rotor magnets mounted on said rotor;
each of said rotor magnets presenting a rotor magnetic pole of a given polarity to said air gap;
each of said rotor magnetic poles generating magnetic flux having a component that extends a direction opposite to said direction of rotation,
each of said rotor magnetic poles being evenly spaced about said axis by an angular distance that is equal to about 360-degrees divided by N,
a plurality N of rotor magnetic flux shields mounted on said rotor and extending between adjacent ones of said rotor magnets to provide an air gap flux window for each of said rotor magnetic poles;
a plurality N+1 of stator magnets mounted on said stator;
each of said stator magnets presenting a stator magnetic pole of said given polarity to said air gap;
said stator magnetic poles each generating magnetic flux having a component that extends generally in said direction of rotation;
each of said stator magnetic poles being evenly spaced about said axis by an angular distance that is equal to about 360-degrees divided by N+1, and
a plurality N+1 of stator magnetic flux shields mounted on said stator and extending between adjacent ones said stator magnets to provide an air gap flux window for each of said stator magnetic poles

2. The motor of claim 1 wherein said stator encircles said rotor

3. The motor of claim 1 wherein said rotor encircles said stator

4 The motor of claim 1 wherein said rotor magnets and said stator magnets are selected from a group consisting of electromagnets and permanent magnets.

5. The motor of claim 1 wherein said rotor magnets are permanent magnets and wherein said stator magnets are selected from a group consisting of electromagnets and permanent magnets.

6. The motor of claim 1 wherein said rotor flux shields and said stator flux shields are formed of a material having high magnetic permeability.

7. The motor of claim 1 wherein said rotor flux shields and said stator flux shields are formed of mumetal.

8. The motor of claim 1 wherein said rotor magnets and said stator magnets are permanent magnets.

9. The motor of claim 8 wherein said permanent magnets contain neodymium.

10. The motor of claim 9 wherein said rotor flux shields and said stator flux shields are formed of a material having high magnetic permeability.

11. The motor of claim 9 wherein said material is mumetal.

12. The motor of claim 1 wherein said plurality N+1 of stator flux shields are mounted for movement about said axis to a position whereat said air gap flux window for at least one of said stator magnetic poles is eliminated.

13. The motor of claim 12 wherein said rotor flux shields and said stator flux shields are formed of a material having high magnetic permeability.

14. The motor of claim 13 wherein said material is mumetal

15. The motor of claim 14 wherein said rotor magnets and said stator magnets are permanent magnets.

16. The motor of claim 15 wherein said permanent magnets contain neodymium.

17. The motor of claim 1 including:
a cylindrical flux shield spaced from said air gap and movable into said air gap to stop movement of said rotor.

18. A method of making a motor comprising the steps of
providing a rotor and a stator;
providing an air gap having a rotor side and a stator side between said rotor and said stator;
providing a number of equally-spaced magnets on said rotor, each magnet presenting a magnetic pole of the given polarity to said rotor side of said air gap;
providing a different number of equally-spaced magnets on said stator, each magnet presenting a magnetic pole of said given polarity to said stator side of said air gap;
providing said number of magnetic flux shields of a material having a high magnetic permeability on said rotor;
providing said different number of magnetic flux shields of a material having a high magnetic permeability on said stator,
arranging said number of magnetic flux shields on said rotor such that said rotor presents said number of equally-spaced rotor flux windows to said rotor side of said gap; and
arranging said different number of magnetic flux shields on said stator such that said stator presents said different number of equally-spaced stator flux windows to said stator side of said air gap;
such that in any position of said rotor relative to said stator, at least one rotor flux window interfaces with at least one stator flux window, thereby causing said rotor to be magnetically repelled from said stator, with resulting movement of said rotor causing a currently-open rotor flux window/stator flux window pair to close, as another rotor flux window/stator flux window pair opens, to thereby effect continuous movement of said rotor

19. The method of claim 18 including the step of,
moving one or both of said rotor flux shields and said stator flux shields to close one or all of said rotor flux window/stator flux window pairs

20. The method of claim 18 wherein said number of equally-spaced magnets on said rotor and said different number of equally-spaced magnets on said stator are permanent magnets.

21. The method of claim 19 wherein said permanent magnets include neodymium.

22. The method of claim 18 wherein said number of equally-spaced magnets on said rotor equals N equally-spaced magnets, and wherein said different number of equally-spaced magnets on said stator equals N+1 equally-spaced magnets.

23. The method of claim 22 wherein said N equally-spaced magnets on said rotor and said N+1 equally-spaced magnets on said stator are permanent magnets.

24. The method of claim 22 wherein said permanent magnets include neodymium.

25. The method of claim 24 including the step of:
moving one or both of said rotor flux shields and said stator flux shields to close one or all of said rotor flux window/stator flux window pairs.

26. The method of claim 18 wherein a ratio of said number of equally-spaced magnets on said rotor to said different number of equally-spaced magnets on said stator is selected from a ratio group consisting of the ratios 4-to-5, 4-to-7 and 4-to-9.

27. The method of claim 25 wherein said magnets on said rotor and said magnets on said stator are permanent magnets.

28. The method of claim 27 wherein said permanent magnets include neodymium.

29 The method of claim 18 wherein:
said number of equally-spaced magnets on said rotor equals X magnets;
said different number of equally-spaced magnets on said stator equals Y magnets;
said numbers X and Y are integers,
said number X is not divisible by said number Y,
said number Y is not divisible by said number X; and
said numbers X and Y are not both divisible by any other common number.

30. The method of claim 18 including the step of:
providing a continuous flux shield for insertion into said air gap when it is desired to stop movement of said rotor.

31. A mechanism for transforming magnetic energy into mechanical energy comprising:
a movable member;
a stationary member;
an air gap between said movable member and said stationary member;
an integer number X of equally-spaced magnets on said movable member, each of said X magnets presenting a magnetic pole of a given polarity to said air gap;
a different integer number Y of equally-spaced magnets on said stationary member, each of said Y magnets presenting a magnetic pole of said given polarity to said air gap;
a first plurality of magnetic flux shields of a material having a high magnetic permeability on said movable member;
said first plurality of magnetic flux shields on said movable member being arranged such that said movable member presents X equally-spaced stationary member flux windows to said air gap;
a second plurality of magnetic flux shields of a material having a high magnetic permeability on said stationary member; and
said second plurality of magnetic flux shields on said stationary member being arranged such that said stationary member presents Y equally-spaced stationary member flux windows to said air gap;
such that in any position of said movable member relative to said stationary member, at least one movable member flux window is aligned with at least one stationary member flux window to thereby form an open window pair, thereby causing said movable member to be magnetically repelled from said stationary member, with resulting movement of said movable member causing a currently open window pair to close, as another window pair opens, to thereby effect continuous movement of said movable member.

32. The mechanism of claim 31 wherein:
X is not divisible by said number Y;
Y is not divisible by said number X; and
X and Y are not both divisible by any other common integer number

33. The mechanism of claim 32 wherein at least said X magnets are permanent magnets.

34. The mechanism of claim 33 wherein said permanent magnets include neodymium.

35. The mechanism of claim 34 wherein said air gap is a circular air gap and wherein said stationary member encircles said movable member.

36. The mechanism of claim 33 wherein said air gap is a circular air gap and wherein said movable member encircles said stationary member

37. The mechanism of claim 36 wherein said first and second plurality of magnetic flux shields are constructed of mumetal
